(19) United States
(12) Patent Application Publication
(10) Pub. No.: US 2023/0046488 A1
(43) Pub. Date: Feb. 16, 2023

(54) A MOULD SET FOR FABRICATION OF AN EPS PALLET AND USE THEREOF

(71) Applicant: Verte Technologies, LLC, Salt Lake City, UT (US)

(72) Inventor: Deenar Shashikant Walawalkar, Mumbai (IN)

(73) Assignee: Verte Technologies, LLC, Salt Lake City, UT (US)

(21) Appl. No.: 17/797,184

(22) PCT Filed: Aug. 4, 2021
(86) PCT No.: PCT/IB2021/057142

§ 371 Date: Aug. 3, 2022

(30) Foreign Application Priority Data
Aug. 24, 2020 (IN) 202021036424

(51) Int. Cl. B29C 44/58; B29C 33/38; B29C 44/02

(52) U.S. Cl. CPC B29C 44/58; B29C 33/3842; B29C 44/02; B29K 2025/06

(57) ABSTRACT

The present invention provides for a mould set for fabrication of an EPS pallet, a process for making the mould set for fabrication of the EPS pallet, and a process for fabricating the EPS pallet using the mould set. The mould set includes a modular platform mould and a leg mould configured to fabricate a platform section and plurality of leg support sections of the EPS pallet, respectively. The modular platform mould includes a modularity unit which enables alternation of dimension of hollow space which is configured to receive feed of polystyrene beads and thereby enabling moulding of the platform section of varying dimensions from a single mould. The one or more leg support sections are affixed to bottom side of the platform section at predefined locations, based on weight bearing capacity and position of lifting, to form the EPS pallet. The easy customization into various sizes as per requirement using a single mould structure reduces requirement of hoarding various moulds for different dimensions of EPS pallet, thereby significantly reducing the cost of moulding operations.

### EARLIEST PRIORITY DATE

This Application claims priority from a Complete patent application filed in India having Patent Application No. 202021036424, filed on Aug. 24, 2020, and titled “A MOULD SET FOR FABRICATION OF AN EPS PALLET AND USE THEREOF”.

### FIELD OF INVENTION

Embodiments of a present invention relate to manufacturing of pallets, and more particularly, to a process for making a mould set for fabrication of Expanded Polystyrene (EPS) pallets and use of the mould set for fabrication of the pallet.

### BACKGROUND

A pallet is a flat transport structure, which supports goods in a stable fashion while being lifted by a forklift, a pallet jack, a front loader, a jacking device, or an erect crane. A pallet is the structural foundation of a unit load which allows handling and storage efficiencies. Pallets are manufactured using different materials such as wood, metals, any recycled products, plastic, Expanded Polystyrene (EPS), High Impact Polystyrene (HIPS), Acrylonitrile butadiene styrene (ABS) or the like. In a conventional approach, manufacturing of such EPS pallets includes designing of a mould and making the pallets using the mould. The process of manufacturing the mould begins with designing of pallets of standard or customised size and shape. The design is based on the application of the pallets such as for a heavy-duty purpose for racking or an export pallet for one-time transit. However, for a standard sized pallet, the designing would not be an issue as the design would have already been developed. On the contrary, for custom designs of the pallet, input from client on the requirement needs to be accommodated to suit the specifications which in turn greatly impacts the design. Any change in the requirement imparts change in the design for the pallet, henceforth the technical drawings needs to be redrawn. Further, a change in the specification or the design may also result in a change in material to be used for forming of the pallet. Designing a tooling for thermoformed plastic is also one of the most challenging step in EPS pallet forming process, since any mistake made at this point will have a negative impact on the EPS core which in turn will replicate on the final product or the EPS pallet. In the light of the aforementioned, it can be easily understood that the moulds can be customized according to the requirement, however the customization will surely increase the capital expenditure and time to implement the same.

Further on designing the mould, the EPS pallet forming process could be initiated. The EPS and HIPS/ABS pallets require two basic raw material, namely the Expanded Polystyrene for making of the Core and High Impact Polystyrene for making of the top layer referred as Sheet. In forming, the EPS is placed on the machine and the sheet is heated up to a pliable temperature. The process includes injecting compressed air between two hot sheets, thus forcing it to conform to the contour of each of two moulds mounted opposed to each other. Evacuation of the air between the sheets is done with help of vacuum. However, such convention approach results in high capital cost as the EPS pallets require a forming machine to form the pallets, Such machines are of high cost. Also, the operation of the machine is energy intensive and requires constant supply of high energy in the form of electricity. The machine also requires two different moulds for operation (a) casting mould to make the EPS Cores and (b) forming mould consisting of TOP and BOTTOM to form the pallets. Every vendor is required to hold a set of Casting mould for every size in order to supply the EPS Cores, which are used as one of the raw materials. This significantly increases the overhead. The higher number of the pallet orders is directly proportional to the increase in capex cost in terms of moulds and machines.

In addition, such machines require huge space. The storing of the casting mould for different sizes makes such an approach cumbersome. It also requires trained manpower with specialized knowledge to operate the equipment to ensure the desired output of the product. In addition, the machines also require regular upkeep and spare support. As the spare support is not quick considering that the machine is imported in most of the cases. Also, the vacuum forming produces thin-walled EPS pallets that have limited impact strength thereby causing structural limitations to the conventional approach.

In comparison with the conventional approach, a newer approach has been disclosed in the US patent baring the patent number U.S. Pat. No. 6,418,861B1, which makes an attempt to resolve the problems of the conventional approach. The patent discloses formation of a modular pallet wherein a pallet is constructed by coupling multiple plates which includes tabs and grooves which aids in combining multiple plates to form a deck. In order to keep the plates intact, it is coupled using multiple beams and rods. However, due to the addition components used to couple the multiple plates, the required materials needed in the newer approach is being increased. Also, this approach becomes less convenient for heavy-duty purposes, as the pallet is week due to multiple bolts and connects, hence such pallets are easily prone to breakage. Due to such limitations, the pallets of the newer approach are restricted to be used by the forklift, the pallet jack, the front loader or any such machines.

Hence there is a need for an improved mould set for fabrication of the pallet and a process thereof to address the aforementioned issues.

### BRIEF DESCRIPTION

In accordance with an embodiment of the disclosure, a mould set for fabrication of an EPS pallet is disclosed. The mould set includes a modular platform mould (70) configured to act as a mould tier a platform section of the EPS pallet. The modular platform mould includes a bottom plate (80) of a pre-defined dimension, a top plate (100) of a pre-defined dimension configured to fit on top of the bottom plate (80) While forming a hollow space (90), corresponding to dimension of the platform section of the EPS pallet, between the top plate (100) and the bottom plate (80), wherein the hollow space (90) is configured to receive feed of polystyrene beads; and a modularity unit configured to alter dimension of the hollow space. The modularity unit includes a first elongated panel (110a) comprising a plurality of first segments (120a), wherein the first elongated panel (110a) is oriented lengthwise on a first side of the bottom plate (80) and housed in the hollow space (90), wherein each of the plurality of first segments is configured to be independently operated laterally to move from a first position to a second position, thereby altering length of the hollow space (90). The modularity unit also includes a second elongated panel (110b) comprising one or more second segments (120b), wherein the second elongated panel (110b) is oriented breadthwise on a second side of the bottom plate (80) housed in the hollow space (90), wherein each of the one or more second segments (120b) is configured to be independently operated laterally to move from a first position to a second position, thereby altering breadth of the hollow space.

In accordance with another embodiment of the disclosure, the mould set for fabrication of an EPS pallet further includes a leg mould (70) configured to act as mould to fabricate a plurality of leg support sections corresponding to the platform section of the EPS pallet, The leg mould includes a bottom layer (150) comprising a plurality' of inlets for at least one of air, water and steam, one or more drain outlets, and one or more openings to receive feed of polystyrene beads. The leg mould includes a mid-layer (160) comprising a plurality of hollow cavities of a pre-defined dimensions, wherein bottom side of the mid layer (160) configured tit over top side of the bottom layer (150). The leg mould also includes a top layer (190) comprising a plurality of inlets for at least one of air, water and steam, one or more drain outlets and configured to fit on top side of the mid layer (160) while sealing the plurality of hollow cavities of the mid layer. The sealed plurality of hollow cavities being configured to receive feed of the polystyrene beads via the one or more openings of the a bottom layer (150) and shape the plurality of leg support sections;

In accordance with yet another embodiment of the disclosure, a process for making a mould set for fabrication of an EPS pallet is disclosed. The process includes drawing a plurality of patterns for base of the modular platform mould (70) and base of a leg mould (200), wherein the pattern comprises plurality of rib points, plurality of feeding points and a steam jet spacing. The process also includes fabricating each of the plurality of patterns independently using one of wood or expandable polystyrene (EPS). The process further includes casting each of the plurality of fabricated patterns. The process includes polishing a plurality of casted patterns using buffing process.

The process also includes combining one or more casted patterns of a plurality of polished patterns for obtaining the modular platform mould (70) and the leg mould (200).

In accordance with an embodiment of the disclosure, a process for making an EPS pallet is provided. The process includes mixing polystyrene beads with at least one antifungal component and fire retardants for preforming of the polystyrene beads. The process also includes heating preformed polystyrene beads, placed in a mesh, for a pre-defined duration and a pre-defined temperature in order to season preformed polystyrene beads. The process further includes transferring seasoned polystyrene beads into a modular platform mould (70) and a leg mould (200). The process includes moulding the seasoned polystyrene beads filled inside the modular platform mould (70) and the leg mould (200) to yield a platform section of the EPS pallet and leg support section of the EPS pallet, respectively. The process also includes stabilising the at least one antifungal component and fire retardants present in moulded platform section and moulded leg support section by drying at a pre-set temperature and duration. The process further includes dedusting a dried platform section and leg support section through a dedusting chamber. The process also includes affixing one or more leg support sections to bottom side of the platform section at predefined locations for form the EPS pallet.

To furtherclarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail wvith the accompanying figures in which:

FIG. 1a is a schematic representation of a cross sectional view of a platform mould of a mould set for fabrication of an EPS pallet of FIG. 1 in accordance with an embodiment of the present disclosure;

FIG. 1b is a schematic representation of a side view of the platform mould of FIG. 1 in accordance with an embodiment of the present disclosure;

FIG. 1c is a schematic representation of a top view of a hollow bottom layer of the platform mould comprising first elongated panel, second elongated panel, first set of levers and second set of levers respectively of FIG. 1 in accordance with an embodiment of the present disclosure;

FIG. 1d is a schematic representation of a side view of the platform mould of FIG. 2c in accordance with an embodiment of the present disclosure;

FIG. 1e is a schematic representation of a bottom view of the platform mould of FIG. 2c in accordance with an embodiment of the present disclosure;

FIG. 1f is a schematic representation of a cross sectional view of the platform mould of FIG. 1c in accordance with an embodiment of the present disclosure;

FIG. 2a is a schematic representation of a side view of a leg mould of the mould set for fabrication of an EPS pallet of FIG. 1 in accordance with an embodiment of the present disclosure;

FIG. 2b is a schematic representation of a cross sectional view of a leg mould of the mould set for fabrication of an EPS pallet of FIG. 1 in accordance with an embodiment of the present disclosure;

FIG. 2c is a schematic representation of a top view of the leg mould comprising a bottom layer, a mis layer and a top layer of FIG. 1 in accordance with an embodiment of the present disclosure;

FIG. 2d is a schematic representation of a bottom view of the eg mould of FIG. 3c in accordance with an embodiment of the present disclosure; and

FIG. 3 is a flow chart representing steps involved in a process for making a mould set for fabrication of an EPS pallet in accordance with an embodiment of the present disclosure; and

FIG. 4 is a flow chart representing steps involved in a process for making an EPS pallet in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an” and and “the” include plural references unless the context clearly dictates otherwise.

Embodiments of the present disclosure relate to a mould set for fabrication of EPS pallet and a process thereof As used herein, the term ‘pallet’ is defined as structural foundation of a unit load which allows handling and storaae efficiencies. An EPS pallet as described herein includes a platform section and one or more leg sections. The mould set comprises a modular platform mould and a leg mould configured to fabricate the platform section and one or more leg sections of EPS pallet, respectively. The platform moulds and one or more leg moulds are referred to as modular since each of the platform mould and the leg mould may be altered as per the desired specification to yield platform sections and leg support sections of varying dimensions.

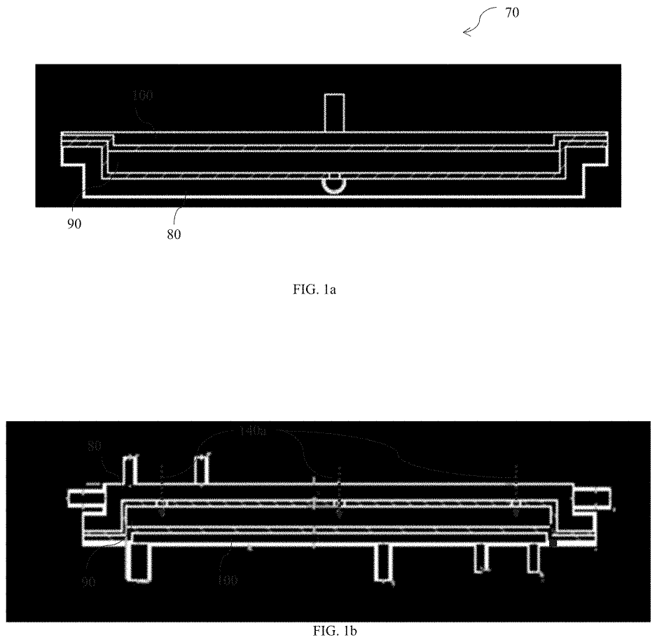

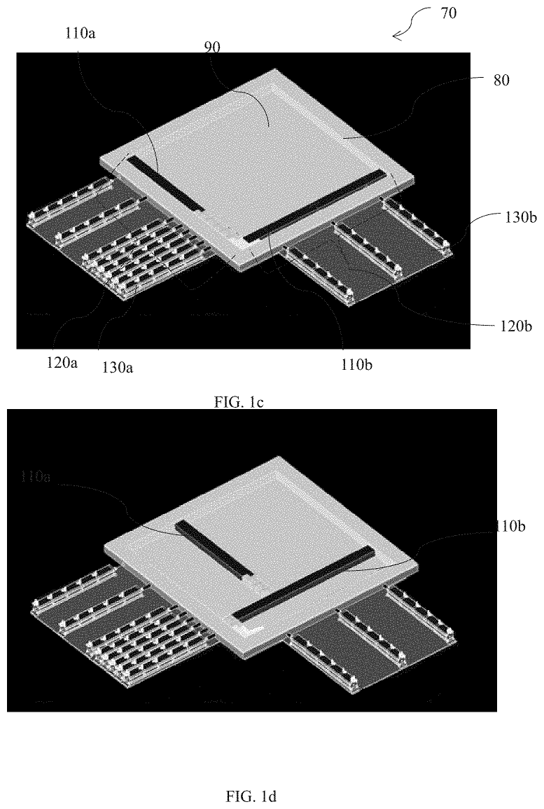

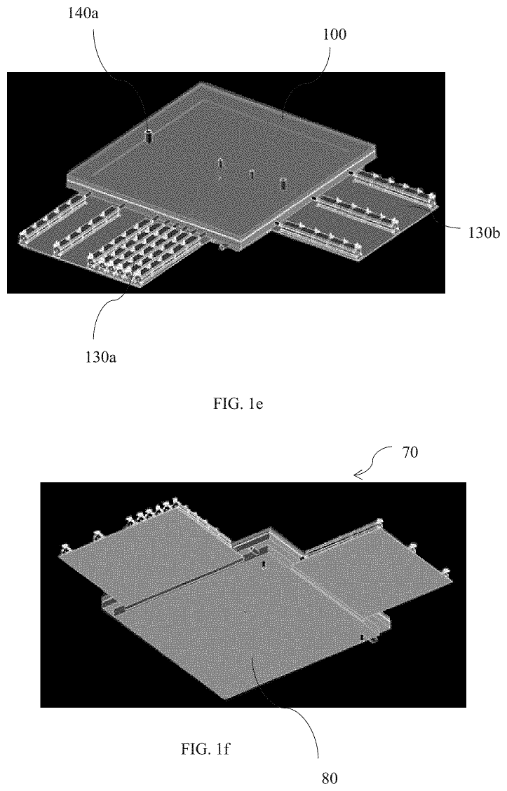

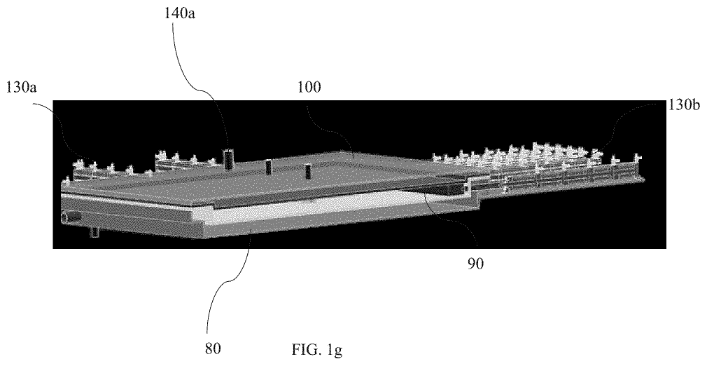

FIGS. la to if illustrate the modular platform mould 70 in accordance with an embodiment of the present disclosure. The FIG. 1a and lb show a cross sectional side views of the modular platform mould 70 in accordance with an embodiment of the present disclosure. The modular platform. includes a bottom plate 80 of a pre-defined dimension, wherein the predefined dimension may be decided as per industry requirements. In one embodiment, the bottom plate 80 may include a wall of a pre-defined height at all edges of the bottom plate 80 thereby creating a hollow space 90 within an inner boundary of the wall, In some embodiments, the dimension of a platform of the hollow bottom plate 80 may be of a shape of a square, a rectangle or the like.

The bottom plate includes a first set of a plurality of openings 140a configured to receive feed of polystyrene beads and guide the polystyrene beads into the hollow space 90 to form the platform section of the EPS pallet.

The bottom plate also includes a second set of plurality of openings configured to enable inlet of at least one of air, water and steam, and enable outlet of water. The second set of plurality of openings are provided with valves configure to enable unidirectional flow.

The modular platform mould also includes a top plate 100 of a pre-defined dimension, configured to fit on top of the hollow bottom plate 80 and define the hollow space 90. The dimension of the hollow space 90 corresponds to a dimension of the platform section of the EPS pallet. More specifically, the top plate 100 may include a plurality of edges which may correspond to the dimensions of the wall of the bottom hollow bottom plate 80. Henceforth, the wall of the hollow bottom plate 80 and the bottom surface of the top plate 100 are coupled to each other in order to keep the hollow space 90 intact.

In an embodiment, the bottom plate comprises a third set of plurality of openings configured to enable inlet of at least one of air, water and steam, and enable outlet of water. The second set of plurality of openings are provided with valves configure to enable unidirectional flow,

The air, water and steam, fed via the second set of plurality of openings and the third set of plurality of openings, are being pressurised inside the modular platform mould 70 to cause expansion of the polystyrene beads inside the hollow space 90.

The modular platform mould also includes a modularity unit (110a and 110b) as shown in FIGS. 1c, 1d, 1c, 1f and 1g in accordance with an embodiment of present disclosure. The modularity unit (110a and 110b) is configured to alter the dimension of the hollow space 90.

The FIG. 1c depicts top view of the modular platform mould including the modularity unit, where the top plate is removed to show inside arrangement. Further, the FIG. 1e depicts top view of the modular platform mould including the modularity unit where the top plate is placed over the bottom plate. The FIG. 1f depicts bottom view of arrangement of the modular platform mould and the modularity unit. The FIG. 1g depicts a cross sectional side view of the arrangement of the modular platform mould and the modularity unit.

The modular unit includes a first elongated panel 110a comprising one or more first segments 120a. The first elongated panel 110a is oriented lengthwise on a first side of the bottom plate 80 and housed in the hollow space 90. In an embodiment, the one or more first segments 120a are detachably attached units, where length of the detachably attached segment may vary. For example, the one or more first segments may include one long segment and other smaller segments. Further, the smaller segments may be configured to have “Z” shape thereby enabling a simultaneous as well as independent movements of the one or more first segments 120a depending on locus of push or pull.

Each of the one or more first segments 120a is configured to be independently operated laterally to move from a first position to a second position, thereby altering length of the hollow space 90. The FIGS. 1c and 1d depict the movement of the first segments 120a from the first position to the second position. However, distance between the first position and the second position may vary as per the requirement. In one embodiment, each of the one or more first segments 120a may be configured to be independently operated laterally to move from the first position to the second position by a first set of levers 130a in a length wise direction. The one or more levers of the first set of levers 130a are mounted with respect to the corresponding one or more first segments 120a and configured to push or pull the corresponding one or more first segments 120a. More specifically, each of the one or more first segments 120a are operatively coupled to the corresponding one of the first set of levers 130a, to operate the corresponding segment laterally in a length wise direction in order to alter the length of the hollow space 90.

For example, the first elongated panel 110a. may include a segment ‘A’ and a segment ‘B’, wherein combining the segment A and segment B forms the first elongated panel which is placed across the length of the hollow space on the hollow bottom plate. Let the modular unit include a lever ‘E’ and a lever ‘F’, wherein the lever E may be operatively coupled to the segment A along for the lateral operation of the same. Similarly, the lever F may be operatively coupled to the segment B along the length for the lateral operation of the same along the length of the hollow space. Further, the lever E and the lever F are operated automatically to enable the movement of the segment A and the segment B, respectively based on the requirement of the alteration of the length dimension of the hollow space. Further, based on the required length, the segment A and the segment B may be moved laterally across the length of the hollow space from the first position to the second position thereby obtaining the platform mould of the required length.

In one exemplary embodiment, the first set of levers 130a are coupled to the corresponding one or more first segments 120a from outside the wall of the hollow bottom plate 80, Each of the first set of levers 130a penetrate through the wall in order to contact the corresponding one or more first segments 120a.

Similarly, the modular unit also includes a second elongated panel 110b comprising one or more second segments 120b. The second elongated panel 120b is oriented breadthwise on a second side of the hollow bottom plate 80 housed in the hollow space 90. Each of the one or more second segments 120b are configured to be independently operated laterally to move from a first position to a second position, thereby altering breadth of the hollow space 90. The FIGS. 1c and 1d depict the movement of the first segments 120b from the first position to the second position. However, distance between the first position and the second position may vary as per the requirement.

In continuation to the above example, consider the second elongated panel to include a segment ‘C’ and a segment ‘ID’, wherein combining the segment C and segment D forms the second elongated panel which is placed across the breadth of the hollow space on the hollow bottom plate. Let the modular unit include a lever ‘G’ and a lever ‘H’, wherein the lever G may be operatively coupled to the segment C along the breadth for the lateral operation of the same, Similarly, the lever H may be operatively coupled to the segment D along the breadth for the lateral operation of the same along the breadth of the hollow space. Further, the lever G and the lever are operated automatically to enable the movement of the segment C and the segment D respectively based on the requirement of the alteration of the breadth dimension of the hollow space. Further, based on the required breadth, the segment C and the segment D may be moved laterally across the breadth of the hollow space from the third first to the second position thereby obtaining the platform mould of the required breadth.

It is evident that the first elongated panel (110a) and the second elongated panel (110b) together define the dimension of the hollow space.

Opening and closing of the first set of a plurality of openings, the second set of plurality of openings, the third set of plurality of openings are controlled via a programmable system. Further, movement of first set of levers (130a) and second set levers (130b) are also controlled via the programmable system as per dimension of a platibrin section and leg support sections provided as input.

In one embodiment, the one or more opening of the first set of a plurality of openings are configured to be activated only when positioned to guide the feed of polystyrene beads to an altered dimension of the hollow space. For example, there may be a scenario where the dimension of the hollow space is altered to be small and as result of that one out of the three openings may happen to be outside of hollow space. Then in such a scenario then opening falling outside the hollow space may not be activated.

In a further embodiment, the mould set for fabrication of an EPS pallet also includes a leg mould (70) configured to act as mould to fabricate a plurality of leg support sections corresponding to the platform section of the EPS pallet.

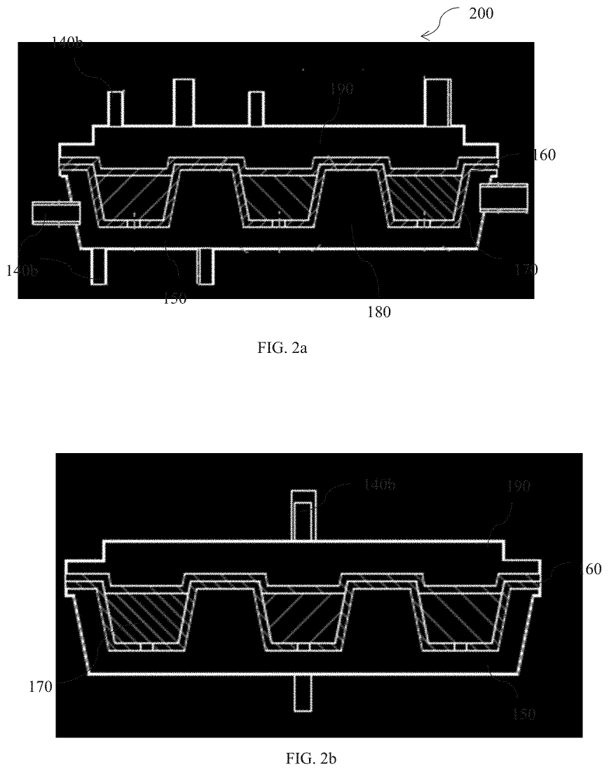

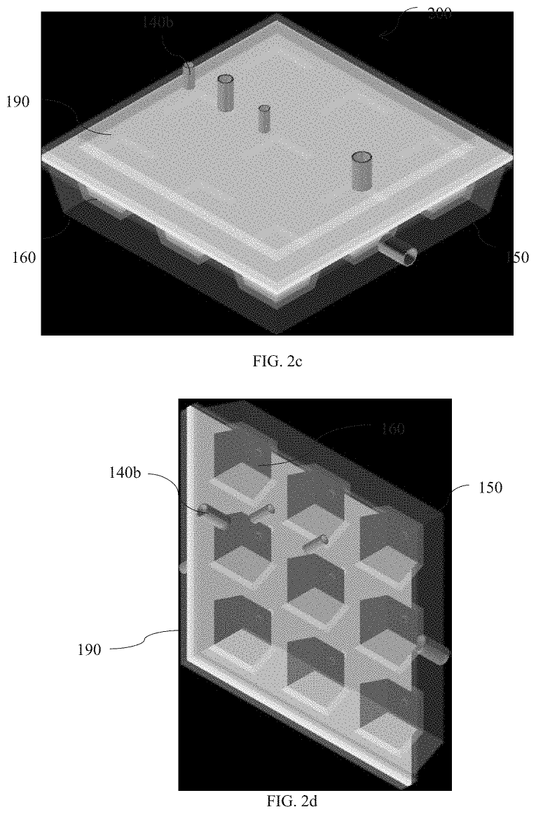

FIGS. 2a-2d illustrate structure of the leg mould from various viewpoints in accordance with the present disclosure.

The FIGS. 2a and 2b illustrate cross sectional front side and rear side views of the leg mould. In an embodiment, the leg mould may include a bottom layer 150, a mid-layer 160 and a top layer 190 fitted on top of each other. The bottom layer 150 may be configured to enclose the mid layer 160. More specifically, the mid layer 160 may be placed on top of the bottom layer 150 in such a way that the dimensions of the bottom layer 150 and the mid layer 160 coincide with one another. Further, the mid layer 160 includes a plurality of hollow cavities 170 of pre-defined dimensions. Each of the plurality of hollow cavities 170 may be fabricated at a pre-defined distance from the adjacent hollow cavity within the mid layer 160. The top layer 190 is configured to fit on top of the mid layer 160 while sealing openings the plurality of hollow cavities of the mid layer. The plurality of hollow cavities 170 being configured to receive feed of the polystyrene beads and yield the leg support section. In one specific embodiment, the mid layer 160 may be configured to be conducted as a female cavity opening and the top layer 190 may be configured to be conducted as a male enclosure for the female cavity.

In an embodiment, the bottom layer (150) includes a plurality of inlets for air, water and steam or combination thereof, one or more drain outlets for removing water, and one or more openings to receive feed of the polystyrene beads.

In another embodiment, the top layer (190) includes a plurality of inlets for air, water and steam or combination thereof, and one or more drain outlets for removing water.

The air, water and steam, fed via the plurality of inlets of the top and bottom layers are being pressurised inside the lea mould to cause expansion of the polystyrene beads inside the plurality of hollow cavities 170 and yield the plurality of leg support sections.

In a further embodiment, the leg mould may also include an external attachment in form of one or more rings, Each of the one or more rings being configured to fit inside the plurality of the hollow cavities and thereby alter dimension of the plurality of the hollow cavities for fabricating the plurality of leg support sections of the altered dimension. The one or more rings may of varying shape and height to cause a corresponding change in shape of the plurality of leg support sections.

Further, the rings may be attached and detached manually or by a machinery means such as a robotic arm or the like.

The platform section and the leg support sections of the EPS pallet are configured to be affixed to each other at predefined positions as per the dimension of the platform and load bearing to obtain an EPS pallet mould.

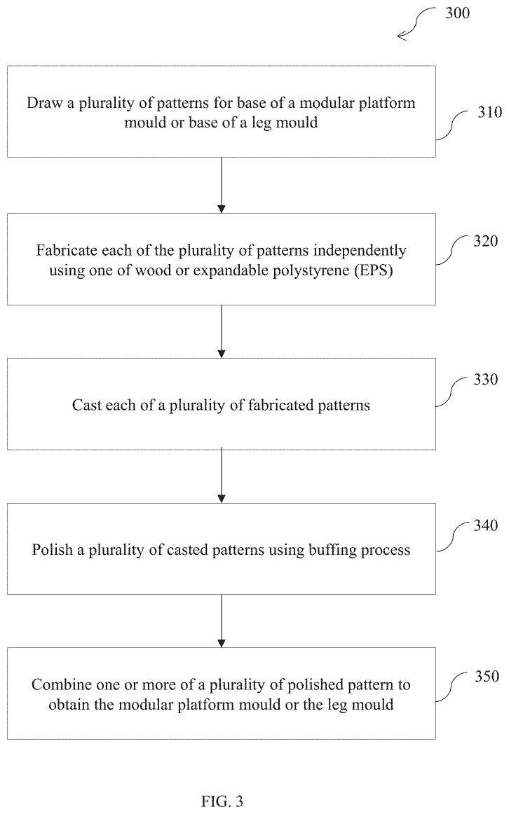

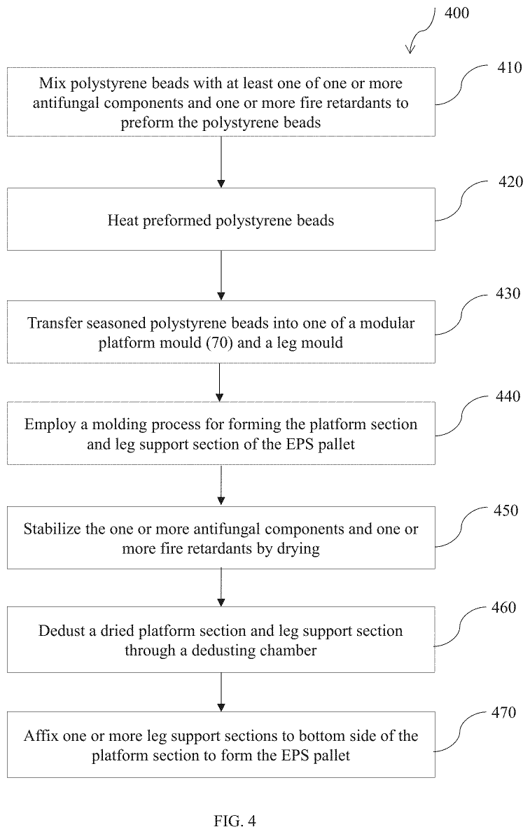

In an embodiment, a process for making a mould set for fabrication of an EPS pallet is provided. FIG. 3 illustrates a flow chart representing steps involved in a process 300 for making a mould set for fabrication of an EPS pallet in accordance with an embodiment of the present disclosure, Each of the multiple mould sets are fabricated in a same procedure which is described hereafter by FIG. 3. The mould set includes a modular platform mould and the leg mould. In one embodiment, the mould set for the EPS pallet is created using a case aluminium method.

The process includes drawing a plurality of patterns for base of one of the modular platform mould (70) and the leg mould (200) at step 310. The plurality of patterns includes a plurality of rib points, a plurality of feeding points and a steam. jet spacing. As used herein, the rib points are thin wall-like structures that add support and rigidity to injection moulded parts,

The process 10 also includes fabricating each of the plurality of patterns independently using one of wood or expandable polystyrene (EPS) in step 320. In one embodiment, the pattern may be achieved/ fabricated using a lost foam technique. The lost foam technique is a type of evaporative-pattern casting process where lost foam is used for the casting process.

The process 10 further includes casting each of a plurality of fabricated patterns in step 330. In one embodiment, the casting of the fabricated pattern may be done using with carbon sand using LM24, wherein LM24 is a pressure die casting aluminium alloy which has excellent casting characteristics; henceforth LM24 may be used for casting of the pallet mould set. In one specific embodiment, the mould set may be fabricated using a computer numerical control (CNC) machine. The CNC machine includes multiple tools and 3D printer to process the material to meet a desired object without human intervention. Henceforth, the CNC machine may be used to process and fabricate the mould set. On obtaining the mould set, one or more space jets are attached based on cooler bag requirement of the EPS pallet.

Furthermore, the process 10 for obtaining the mould set includes polishing a plurality of casted patterns using buffing process in step 340. The polishing of the casted pattern is achieved to smoothen the plurality of casted pattern to obtain a finished mould set for the EPS pallet. The above described process 10 is done to obtain the modular platform moulds and the leg moulds. One obtaining the same, combining one or more casted patterns of a plurality of polished patterns for obtaining one of the modular platform mould (70) and the leg mould (200) in step 350.

In one exemplary embodiment, the process 10 includes a Teflon coating method on one or more of critical shape inserts the mould set for faster cooling and ejection. In one exemplary embodiment, multiple fixtures may be fabricated which may be configured to alter the size of the modular platform moulds. The multiple fixtures may be composed of brass for long life and better cooling. The plurality of polished pattern includes the modular platform moulds and the leg moulds. The platform section together with the leg section form the EPS pallet mould. On obtaining the EPS pallet mould of the desired specification and dimension, the EPS pallets are fabricated.

In another embodiment, a process for making an EPS pallet using the modular platform mould (70) and the leg mould (200) is provided. FIG. 4 illustrates a flow chart representing steps involved in a process 400 for making an EPS pallet in accordance with an embodiment of the present disclosure.

The process 400 includes mixing polystyrene beads with at least one of one or more antifungal components and one or more fire retardants for preforming of the polystyrene beads in step 410. In one embodiment, the at least one antifungal component may be in a form. of powder with fire retardant grade. The one or more EPS raw material may be in a form of granules. On mixing the two components, antifungal property is imparted to the EPS pallets.

The process 200 includes heating preformed polystyrene beads, placed in a mesh, for a pre-defined duration and a pre-defined temperature in order to season preformed polystyrene beads in step 420, The preformed material is placed in nylon mesh silos and is heated at about 45° C. for about 2 to 4 hours, preferably for 3 hours. Temperature above 45° C. may cause the mixture to lose the antifungal property, henceforth, the temperature is critically maintained at a fixed rate to obtain seasoned material.

Further, the process 400 includes transferring seasoned polystyrene beads into one of the modular platform mould (70) and the leg mould (200) in step 430.

In a further embodiment, the process may also include moulding and addition of inserts to impart additional strength to the EPS pallet. This process method may be employed based on the pattern design. In such embodiment, moulding the inserts may include moulding one of metal wire mesh, plates, angles, corners, rods or the like. The inserts may be composed of a metal such as non-corrosive steel and its alloys which may enhance the load bearing capacity of the EPS pallets to the tune of 7 to 8 tons. In some embodiments of the invention, inserts of specially made fixtures also incorporate wheels for easy movement for specific requirements of pallets.

The process 400 for making an EPS pallet moulding the seasoned polystyrene beads filled inside the modular platform mould (70) and the leg mould (200) to yield a platform section of the EPS pallet and leg support section of the EPS pallet, respectively in step 440. In one embodiment, the moulding process may include a steam moulding process. Here, the seasoned material is filled into the mould set through the feeding points of the mould set via the moulding machine, further to which the seasoned material is subjected to stem for a pre-defined amount oftime at a specific pressure level.

On reaching the desired interval of time, the steamed material inside the mould set is subjected to cooling or drying. More specifically, the process 200 includes stabilising the at least one antifungal component and fire retardants present in moulded platform section and moulded leg support section by drying at a pre-set temperature and duration in step 450. The drying of the moulded pallets is achieved by placing the mould sets at a temperature of about 45 degrees in a. drying room not more than a time period of about 4 hours in order to maintain the antifungal property of the moulded pallets. In one exemplary embodiment, the drying may be achieved by placing the moulded pallets in a specially designed drying chamber. Once the material inside the mould set is dried, the moulded pallet is de-moulded from the mould sets to obtain the pallet of desired dimensions.

The process 400 includes dedusting a dried platform section and leg support section through a dedusting chamber for enhancing the finish of the EPS pallet in step 460.

The dedusting process is performed to make the surface clean and to remove any foreign particles from the de-moulded pallets.

The process 400 also includes affixing one or more leg support sections to bottom side of the platform section at predefined locations to form the EPS pallet. The predefined locations for affixing the one or more leg support sections to the platform section is determined based on weight bearing capacity and position of lifting the EPS pallet.

Various embodiments of the present disclosure enable the mould set for fabrication of the pallet and a process thereof in reducing the overall capital cost, by virtue of the unique way of breaking the mould into two or more parts and later binding the parts of the mould together with a special adhesive enables easy customization with respect to size of the mould. The base of the mould is designed later with strengthening ribs and feeding points and steam jet spacing. The easy customization into various sizes as per client requirement using a single mould structure having segments to alter the mould size, reduces requirement of hoarding various moulds for different dimensions. Also, requirement of the space for the moulds is reduced, since holding the casting moulds for varied sizes and dimensions is not required in the proposed invention.

In addition, the load bearing capacity of the EPS pallets is increased due to the insertion of the inserts in the form of wire, mesh, inserts, plates, angles, corners, rods, or the like as per the design requirement which enhances the load hearing capacity of the pallets to the tune of 7 to 8 tons. Also, the matrix coating of the pallets makes the process economic and efficient for coating. The use of specific blends of polyurea, polyurethane, and silicon elastomer to impart a desired property such as high impact and abrasion resistance, flexural or elongation strength, anti-static property along with high impact and flexural strength. The matrix coating gives much stronger bonding due to overlap on the sides and reduces the wastage of coating material, This process also reduces the flying of the coating particles away and will increase the productivity.

Also, due to the usage of the adhesive material for coupling the multiple moulds, the additional units for coupling the same is eliminated thereby making the mould set more sturdy for all purposes. Also, the pallet fabricated through the mould set remains a single piece, thereby handling such pallets is more convenient. Henceforth, such an approach of fabricating a modular mould set or the pallet is more reliable.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A mould set for fabrication of an EPS pallet, comprising:
a modular platform mould (70) configured to act as a mould for a platform section of the EPS pallet, wherein the modular platform mould comprises:
a bottom plate (80) of a pre-defined dimension;
a top plate (100) of a pre-defined dimension configured to fit on top of the bottom plate (80) while forming a hollow space (90), corresponding to dimension of the platform section of the EPS pallet, between the top plate (100) and the bottom plate (80), wherein the hollow space (90) is configured to receive feed of polystyrene beads;
a modularity unit configured to alter dimension of the hollow space, wherein the modularity unit comprises
a first elongated panel (110a) comprising a plurality of first segments (120a), wherein the first elongated panel (110a) is oriented lengthwise on a first side of the bottom plate (80) and housed in the hollow space (90), wherein each of the plurality of first segments is configured to be independently operated laterally to move from a first position to a second position, thereby altering length of the hollow space (90); and
a second elongated panel (110b) comprising one or more second segments (120b), wherein the second elongated panel (110b) is oriented breadthwise on a second side of the bottom plate (80) housed in the hollow space (90), wherein each of the one or more second segments (120b) is configured to be independently operated laterally to move from a first position to a second position, thereby altering breadth of the hollow space.

2. The mould set for fabrication of an EPS pallet as claimed in claim 1, wherein the a bottom plate comprises first set of a plurality of openings configured to receive feed of polystyrene beads and guide the polystyrene beads into the hollow space (90) to thrill the platform section of the EPS pallet.

3. The mould set for fabrication of an EPS pallet as claimed in claim 2, wherein one or more opening of the first set of a plurality of openings are configured to be activated when positioned to guide the feed of polystyrene beads to an altered dimension of the hollow space.

4. The mould set for fabrication of an EPS pallet as claimed in claim 1, wherein the bottom plate comprises a second set of plurality of openings configured to enable inlet and outlet of at least one of air, water and steam.

5. The mould set for fabrication of an EPS pallet as claimed in claim 1, wherein the top plate comprises a third set of plurality of openings configured to enable inlet and outlet of at least one of air, water and steam.

6. The mould set for fabrication of an EPS pallet as claimed in claim 1, wherein each segment of the plurality of first seaments (120a) is configured to be independently operated laterally to move from the first position to the second position via a corresponding first set of levers (130a), wherein one or more levers of the first set of levers are mounted with respect to the corresponding plurality of first segments (120a) and configured to push or pull each segment of the plurality of first segments (120a).

7. The mould set for fabrication of an EPS pallet as claimed in claim 1, wherein each of the one or more second segments (120b) are configured to be operated in the elongated direction along the second side within the hollow space (90) independently via a corresponding second set levers (130b), where one or more lever of the second set levers (130b) are mounted with respect to corresponding one or more second segments (120b) and configured to push or pull each of the one or more second segments (12%) to obtain a desired dimension of the hollow space.

8. The mould set for fabrication of an EPS pallet of claim 1, wherein the mould set further comprises a leg mould (70) configured to act as mould to fabricate
a plurality of leg support sections corresponding to the platform section of the EPS pallet, wherein the leg mould comprises:
a bottom layer (150) comprising a plurality of inlets for at least one of air, water and steam, one or more drain outlets, and one or more openings to receive feed of polystyrene beads;
a mid layer (160) comprising a plurality of hollow cavities of a pre-defined dimensions, wherein bottom side of the mid layer (160) configured fit over top side of the bottom layer (150),
a top layer (190) comprising a plurality of inlets for at least one of air, water and steam and one or more drain outlets, and configured to fit on top side of the mid layer (160) while sealing the plurality of hollow cavities of the mid layer,
wherein sealed plurality of hollow cavities being configured to receive feed of the polystyrene beads via the one or more openings of the bottom layer (150) and shape the plurality of leg support sections.

9. The mould set for fabrication of an EPS pallet of claim 8, wherein the leg mould further comprises one or more rings configured to fit inside the plurality of the hollow cavities and thereby alter dimension of the plurality of the hollow cavities for fabricating the plurality of leg support sections of the altered dimension.

10. A process (300) for making a mould set for fabrication of an EPS pallet comprising:
drawing a plurality of patterns for base of one of a modular platform mould (70) and a leg mould (200), wherein the paftern comprises plurality of rib points, plurality of feeding points and a steam jet spacing;
fabricating each of the plurality of patterns independently using one of wood or expandable polystyrene (EPS);
casting each of the plurality of fabricated patterns;
polishing a plurality of casted patterns using buffing process; and
combining one or more casted patterns of a plurality of polished patterns for obtaining one of the modular platform mould (70) and the leg mould (200).

11. A process (400) for fabricating an EPS pallet comprising:
mixing polystyrene beads with at least one of one or more antifungal components and one or more fire retardants for preforming of the polystyrene beads;
heating preformed polystyrene beads, placed in a mesh, for a pre-defined duration and a pre-defined temperature in order to season preformed polystyrene beads;
transferring seasoned polystyrene beads into one of a modular platform mould (70) and a leg mould (200);
moulding the seasoned polystyrene beads filled inside the modular platform mould (70) and the leg mould (200) to yield a platform section of the EPS pallet and leg support section of the EPS pallet, respectively;
stabilising the at least one antifungal component and fire retardants present in moulded platform section and moulded leg support section by drying at a pre-set temperature and duration;
dedusting a dried platform section and leg support section through a dedusting chamber; and
affixing one or more leg support sections to bottom side of the platform section at predefined locations to form the EPS pallet.

12. The process for making an EPS pallet of claim 11, wherein the pre-defined temperature for heating preformed polystyrene beads comprises 45° C.

13. The process for making an EPS pallet of claimn 11, wherein the pre-defined duration for heating preformed polystyrene beads comprises 3 hours.

14. The process for making an EPS pallet of claim 11, wherein the pre-set temperature for drying comprises 45° C.

15. The process for making an EPS pallet of claim 11, wherein the pre-set duration for drying comprises 2 to 4 hours.

16. The process for making an EPS pallet of claim 11, wherein the predefined locations for affixing the one or more leg support sections to the platform section is determined based on weight bearing capacity and position of lifting the EPS pallet.
